(19) United States
(12) Patent Application Publication
(10) Pub. No.: US 2015/0083275 A1
(43) Pub. Date: Mar. 26, 2015

(54) CUTTING SHAFT FOR VERTICAL STUMP GRINDER

(71) Applicant: New River Equipment Corp., Canton, OH (US)

(72) Inventors: James J. Paumier, Canton, OH (US); Todd D. Mattison, Wooster, OH (US); David B. Mattison, Smithville, OH (US)

(21) Appl. No.: 14/496,297

(22) Filed: Sep. 25, 2014

Related U.S. Application Data
(60) Provisional application No. 61/882,696, filed on Sep. 26, 2013.

(51) Int. Cl. A01G 23/06; B23D 61/06

(52) U.S. Cl. CPC A01G 23/067; B23D 61/06
USPC 144/24.12; 144/218

(57) ABSTRACT

The invention relates to a stump grinder that rotates about a vertical axis and includes an improved cutting shaft. The improved cutting shaft includes a base portion attached to a drive source, and a grinding shaft attached to and extending downwardly from the base portion. The grinding shaft includes replaceable cutting teeth and a replaceable grinding tip.

### CROSS-REFERENCE TO RELATED APPLICATION

This application claims the benefit of U.S. Provisional Patent Application Ser. No. 61/882,696, filed Sep. 26, 2013.

### BACKGROUND OF THE INVENTION

1. Field of the Invention

The invention relates generally to the art of removing tree stumps with a grinding shaft. More particularly, the invention relates to a grinding shaft that rotates. More specifically, the invention relates to a stump grinder that rotates about a vertical axis and includes a replaceable cutting portion and a replaceable grinding tip.

2. Background Art

The use of a grinding apparatus having an elongated grinding wheel rotatable about a horizontal axis has been very popular in the stump grinding industry for many years. Generally, the grinding wheel that rotates about a horizontal axis removes tree stumps to allow the property owner to remove tree stumps before the tree stump causes damage to people and/or property. For example, a person could trip over the tree stump and/or potentially injure themselves. Further, upon performing general maintenance upon the property, including cutting the grass on the property, equipment may contact the elevated stump causing damage to the equipment or potential injury to people in the vicinity. Additionally, a tree stump may invite unwanted pests that could do damage to the surrounding land and/or surrounding structures.

As a result, stump grinders were developed to remove tree stumps before the stumps could become a safety hazard to the property owner and/or others. Further, removal of tree stumps prevents damage to equipment that may be utilized on the property.

Generally, prior art stump grinders include a wheel that rotates about a horizontal axis, which is known in the art as a horizontal stump grinder. The wheel is typically powered by a machine. The stump grinder operates by moving through the stump in a direction parallel with the axis of the cutting wheel. In this manner, the drive shaft and the bearings are below the ground level where each component is exposed to dirt and rocks, which may create undesirable wear and/or damage to the components.

Additionally, debris from grinding the tree stump and surrounding area may include wood and rocks which may be thrown vertically from the grinding area by a horizontal stump grinder, constituting a safety hazard. Another problem with a horizontal stump grinder is that a wheel with a large diameter is required to grind deep enough to remove the tree stump. The larger diameter wheel requires more power, which further requires more powerful machinery. Further, such a large diameter wheel may have a greater tendency to climb up on the stump being removed during operation, which may disturb the vehicle on which the wheel is mounted.

As a result of the issues associated with horizontal stump grinders, prior art vertical stump grinders were developed. A vertical stump grinder includes an elongated grinding shaft that rotates about a vertical axis for drilling into the ground and then moving horizontally into the sides of the stump where the debris and/or rocks are thrown horizontally below ground around the grinding shaft.

Similar to a horizontal stump grinder, the prior art vertical stump grinding shaft is attached to a machine that rotates the shaft. Prior art vertical stump grinders include teeth that are welded to the grinder shaft, which facilitate grinding of the tree stump and other debris, including tree roots, rocks, and dirt. A disadvantage of prior art vertical stump grinders is that, upon continued utilization of the grinder, the teeth attached to the vertical stump grinder shaft may become worn out or broken, and/or otherwise require replacement. Further, prior art vertical grinders are limited to replacing the entire grinding shaft, or cutting shaft, when the teeth are worn out and/or broken. In this manner, the entire grinder shaft must be replaced, thus requiring purchasing a potentially costly replacement grinder shaft. Additionally, the installation cost and corresponding amount of time to install the replacement increases the downtime of the prior art vertical stump grinder.

Therefore, a need exists in the art for a vertical stump grinder that includes replaceable teeth to minimize the replacement cost and to minimize installation time of worn out and/or broken teeth without replacing the entire cutting shaft or grinding shaft. Additionally, a need exists for a vertical stump grinder that includes a replaceable grinding tip, or puck, that may be removed and replaced.

The improved shaft for vertical stump grinder of the present invention solves the problems associated with prior art vertical stump grinder by providing replaceable cutting teeth and a backer, which enable the teeth to be replaced without replacing the entire vertical stump grinder shaft. Additionally, the improved cutting shaft for a vertical stump grinder of the present invention includes a replaceable grinding tip that facilitates removal of tree stumps and corresponding tree roots.

### SUMMARY OF THE INVENTION

An objective of the present invention includes providing an improved cutting shaft for a vertical stump grinder that includes a grinding shaft with replaceable cutting teeth, allowing for the cutting teeth to be replaced without replacing the entire grinding shaft, thereby resulting in decreased down time and decreased maintenance costs.

A further objective of the present invention is to provide an improved cutting shaft for a vertical stump grinder that includes a grinding shaft with a replaceable grinding tip that facilitates removal of tree stumps, roots, and other debris, resulting in decreased grinding time and decreased maintenance costs.

These objectives and advantages are obtained by an improved cutting shaft for a vertical stump grinder, the cutting shaft including a base portion attached to a drive source, and a grinding shaft attached to and extending downwardly from the base portion. The grinding shaft includes at least one cutting tooth removably attached to the grinding shaft.

### BRIEF DESCRIPTION OF THE SEVERAL VIEWS OF THE DRAWINGS

The preferred embodiments of the present invention, illustrative of the best mode in which the Applicants have contemplated applying the principles, are set forth in the following description and are shown in the drawings.

FIG. 1 is a side elevational view of a prior art vertical stump grinder mounted on a skid steer loader, showing the prior art vertical grinder in the underground operating position;

FIG. 2 is a side elevational view of a prior art vertical stump grinder having a conical end and a cylindrical body, removed from the skid steer loader;

FIG. 3 is a perspective side view of first embodiment improved cutting shaft for a vertical stump grinder of the present invention, showing a backer support, a replaceable cutting portion and a replaceable grinding tip;

FIG. 4 is a side elevational view of the improved cutting shaft for a vertical stump grinder of the present invention shown in FIG. 3;

FIG. 5 is an enlarged perspective view of a backer support shown in FIG. 3;

FIG. 6 is an enlarged perspective view of a cutting portion shown in FIG. 3;

FIG. 7 is an enlarged perspective view of the grinding tip shown in FIG. 3;

FIG. 8 is an exploded perspective view of the attachment of the grinding tip to the improved cutting shaft for a vertical stump grinder shown in FIG. 7;

FIG. 9 is another exploded perspective view of the attachment of the grinding tip to the improved cutting shaft shown in FIG. 7;

FIG. 10 is a bottom view of another grinding tip for the improved cutting shaft for a vertical stump grinder of the present invention;

FIG. 11 is a side elevational view of the grinding tip shown in FIG. 10;

FIG. 12 is a bottom view of another grinding tip for the improved cutting shaft for a vertical stump grinder of the present invention;

FIG. 13 is a side elevational view of the grinding tip shown in FIG. 12;

FIG. 14 is an exploded perspective view of another grinding tip for the improved cutting shaft for a vertical stump grinder of the present invention;

FIG. 15 is another exploded perspective view of the attachment of the grinding tip to the improved cutting shaft shown in FIG. 14;

FIG. 16 is an exploded perspective view of the improved cutting shaft for a vertical stump grinder of the present invention with weighted rings;

FIG. 17 is an isolated exploded perspective view of weighted rings shown in FIG. 16;

FIG. 18 is a cross-sectional view of another cutting tooth structure attached to the improved cutting shaft for a vertical stump grinder of the present invention;

FIG. 19 is a cross-sectional view of another cutting tooth structure attached to the improved cutting shaft for a vertical stump grinder of the present invention;

FIG. 20 is a cross-sectional view of another cutting tooth structure attached to the improved cutting shaft for a vertical stump grinder of the present invention;

FIG. 21 is an exploded perspective view of another cutting tooth structure for the improved cutting shaft for a vertical stump grinder of the present invention;

FIG. 22 is another exploded perspective view of the cutting tooth structure shown in FIG. 21; and

FIG. 23 is a cut-away perspective view of a second embodiment improved cutting shaft for a vertical stump grinder of the present invention.

Similar numerals refer to similar parts throughout the drawings.

### DESCRIPTION OF THE PREFERRED EMBODIMENT

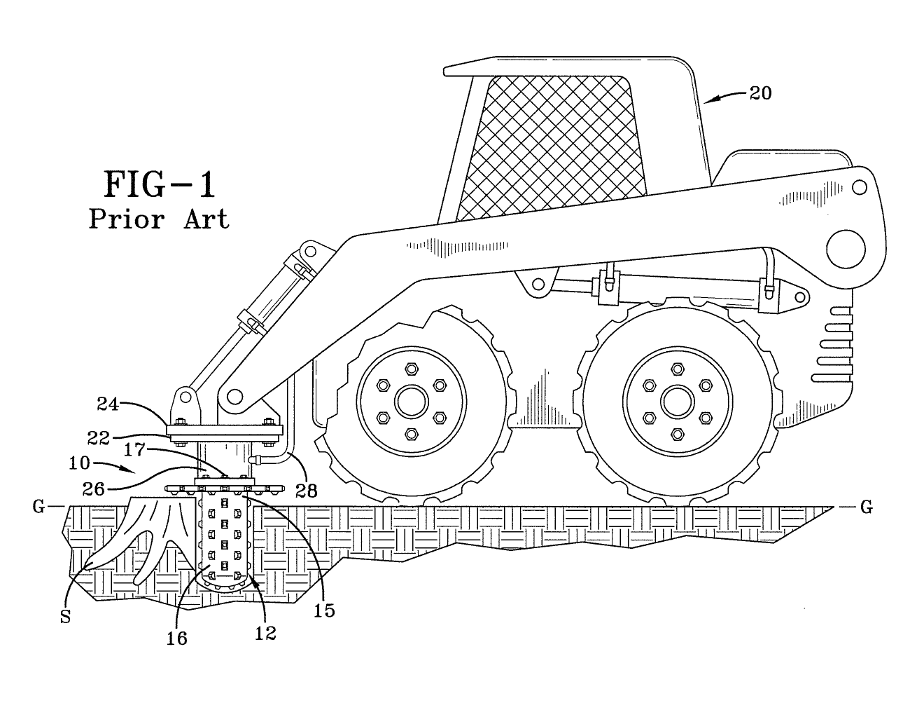

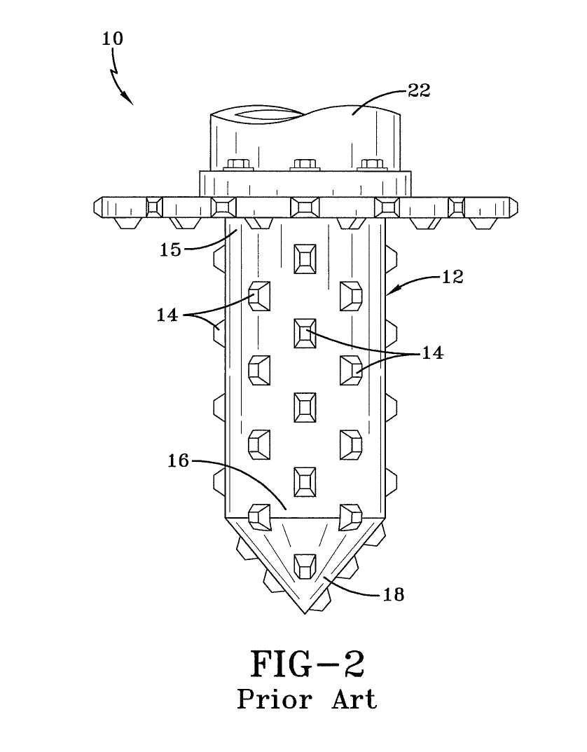

In order to better understand the environment in which the improved cutting shaft for a vertical stump grinder of the present invention is utilized, a prior art vertical stump grinder is indicated generally at reference numeral 10, is shown in FIGS. 1-2, and now will be described in detail.

Prior art vertical stump grinder 10 is shown mounted on a skid steer loader 20. Prior art vertical stump grinder 10 includes a support member or flange 22 mounted on a bucket beam 24 of skid steer loader 20. Flange 22 may be for a drive source 26, such as a drive unit or drive shaft, having a hydraulic fluid pressure hose 28 connected to a hydraulic pump in skid steer loader 20. Prior art vertical stump grinder 10 includes a grinding shaft 12, or cutting shaft, that is generally cylindrical shaped, tapers at a terminal end 18, and includes a plurality of cutting teeth 14 mounted on a surface 16 of the grinding shaft. Prior art vertical stump grinder 10 is removably mounted to skid steer 20 which provides sufficient power to rotate grinding shaft 12 about a vertical axis, by bolting a mounting end 15 of the grinding shaft to drive source 26.

Cutting teeth 14 of prior art vertical stump grinder 10 are generally rigidly attached to surface 16 of grinding shaft 12 by means known in the art, such as welding, and typically are made of a steel alloy. Upon continued use of prior art vertical stump grinder 10, cutting teeth 14 would wear out, and/or break off, as a result of the harsh environment of the stump area S including rocks, wood, soil, and/or other debris above, below, and around ground level G. After a sufficient number of cutting teeth 14 were worn out and/or broken, prior art vertical stump grinder 10 would become less efficient at grinding tree stumps and would require replacement.

Replacing prior art vertical stump grinder 10 requires purchasing another grinding shaft 12, thus requiring additional capital investment cost and lost time to remove the worn prior art vertical stump grinder and install the replacement grinding shaft. The additional capital investment cost and time lost are significant disadvantages associated with prior art vertical stump grinders.

Therefore, a need exists in the art for a vertical stump grinder that includes a grinding shaft that includes replaceable cutting teeth such that when individual teeth are worn out and/or broken, the entire grinding shaft does not have to be replaced, thereby minimizing cost and time. Further, there is a need in the art for a vertical stump grinder shaft that includes a grinding tip on the terminal or bottom end of the grinder shaft that may be replaced upon the grinding tip becoming worn out and/or broken. The improved cutting shaft for a vertical stump grinder of the present invention accomplishes these needs, and the structure and installation of the improved cutting shaft is described in detail below.

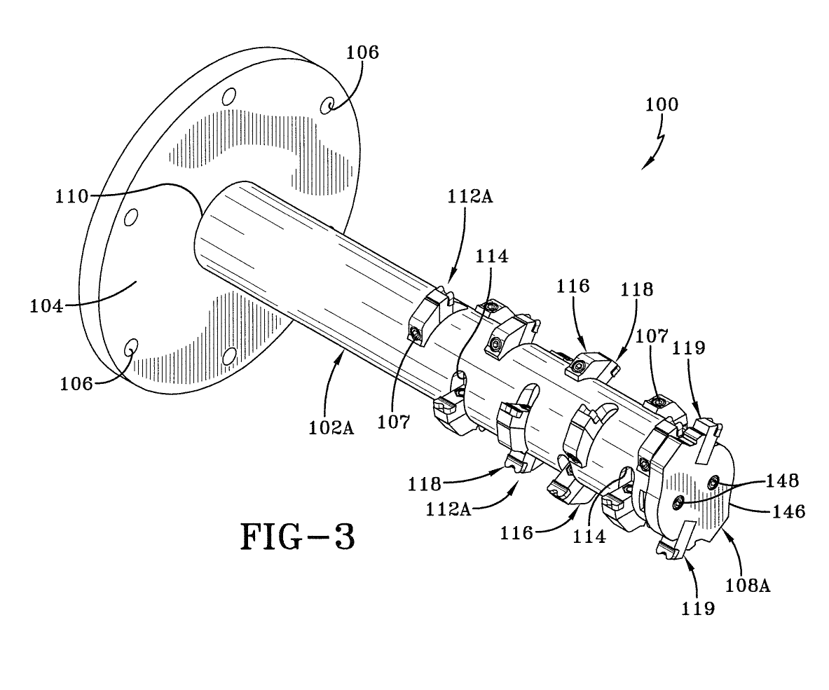

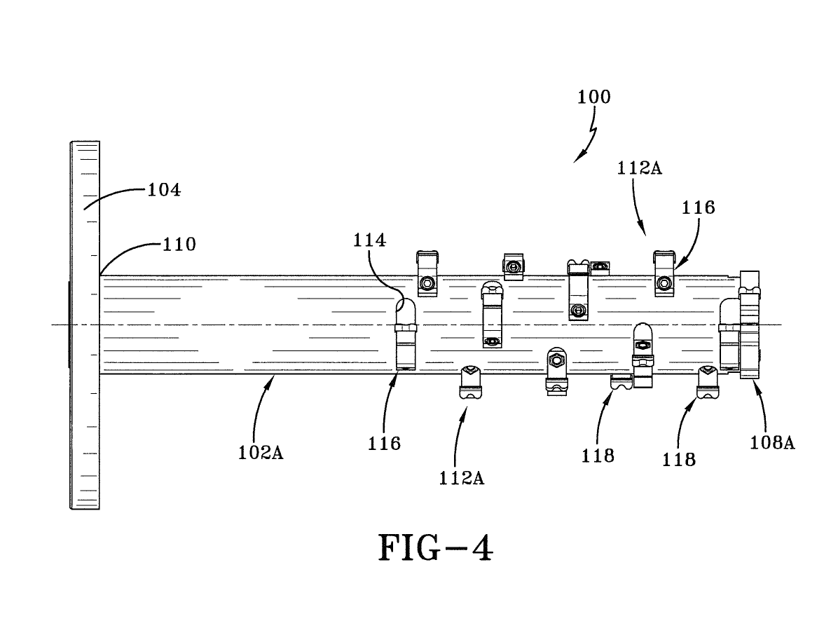

A first embodiment of an improved cutting shaft for vertical stump grinder of the present invention is shown in FIGS. 3-4, at reference numeral 100. First embodiment cutting shaft for vertical stump grinder 100 of the present invention includes a cutting shaft or grinding shaft 102A, a base portion 104, and a puck, or grinding tip 108A.

Base portion 104 is generally disk shaped and is formed with a plurality of openings 106. Fasteners 17 (FIG. 1) are disposed through openings 106 to attached base portion to a vehicle drive source 26 (FIG. 1) of driven equipment, such as skid steer loader 20 (FIG. 1). In this manner, the vehicle provides the power to rotate first embodiment cutting shaft for vertical stump grinder 100, as will be discussed below.

Base portion 104 is generally rigidly attached to grinding shaft 102A at an intersection 110 by welding, taper lock, or other means known by those in the art. Grinding shaft 102A includes a plurality of cutting teeth 112A disposed about the circumference and along the length of the shaft. Grinding shaft 102A also is formed with a plurality of grooves 114, each one of which corresponds to one of cutting teeth 112A. Each cutting tooth 112A includes a backer support 116 and a cutting portion 118. Backer support 116 is generally rigidly attached to groove 114 of grinding shaft 102A by welding or other means known by those in the art.

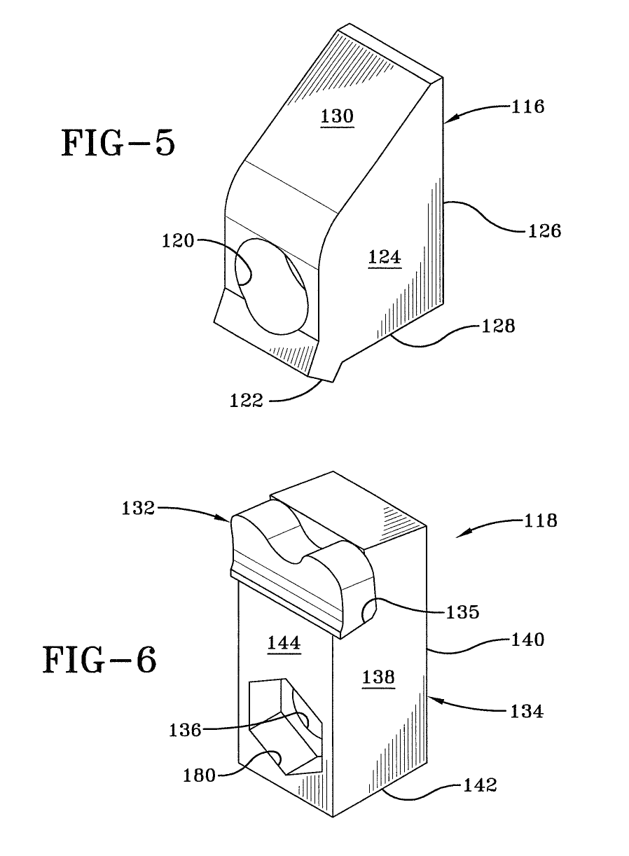

With additional reference to FIG. 5, backer support 116 is generally rectangular shaped and formed with an opening 120. Additionally, backer support 116 includes a tail portion 122, a pair of side portions 124 (only one shown), a cutting support portion 126, a base portion 128, and an angled portion 130. Tail portion 122 provides an optimum weld location and helps to align backer support 116 with respect to groove 114. Base portion 128 seats in and is rigidly attached to groove 114 by welding or other means known by those in the art. In addition, tail portion 122 provides additional surface area to attach backer support 116 to grinding shaft 102A. In this manner, backer support 116 is rigidly attached to grinding shaft 102A. Preferably, backer support 116 is welded within groove 114 of grinding shaft 102A. Further, tail portion 122 provides a locating means for correct positioning of backer support 116 within groove 114. In this manner, backer support 116 is properly positioned upon grinding shaft 102A and assists the installation of the backer support.

A fastener 107 (FIG. 3), such as a bolt, is disposed in opening 120 of backer support 116 to rigidly attach cutting portion 118 to the backer support, as will be described below.

Turning to FIG. 6, cutting portion 118 is generally rectangular in shape and includes a cutting tip 132 and a cutting tip support 134. Cutting tip support 134 is formed with an opening 136 and a recess 180 to prevent rotation of the nut (not shown) and to provide protection from abrasive conditions. Cutting tip support 134 includes a pair of side supports 138 (only one shown), a cutting backer portion 140, a foundation portion 142, and a fastener portion 144. Cutting tip support 134 is formed with a notch or cutout feature 135, which receives cutting tip 132.

Cutting tip 132 seats in notch 135 and is rigidly attached to cutting tip support 134, preferably by brazing. Cutting tip 132 is generally made of a metal carbide alloy, as known to those skilled in the art, and includes a generally elongated “m-shape”, but other shapes, including a generally “U-shape”, are contemplated.

In an important aspect of the present invention, cutting portion 118 is removably attached to backer support 116. More specifically, once backer support 116 is welded into groove 114 to provide proper alignment for cutting portion 118, cutting backer portion 140 is abutted against cutting support portion 126 of the backer support. Opening 120 of backer support 116 is aligned with opening 136 of cutting portion 118 and fastener 107 (FIG. 3) is disposed therein. In this manner, cutting portion 118 is removably attached to backer support 116 and may be easily removed if the cutting portion becomes worn out and/or broken or otherwise needs replacement.

In addition to utilizing cutting tip 132 of cutting portion 118 to grind and/or cut tree stumps, tree roots and/or other debris, improved cutting shaft for vertical stump grinder 100 includes a grinding tip 108A connected to the bottom end of the vertical stump grinder.

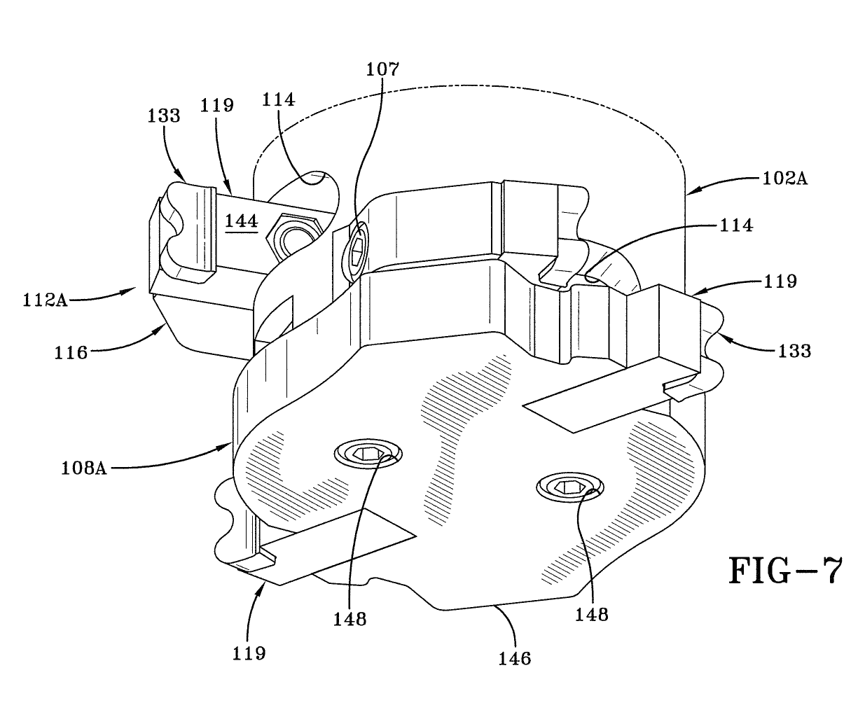

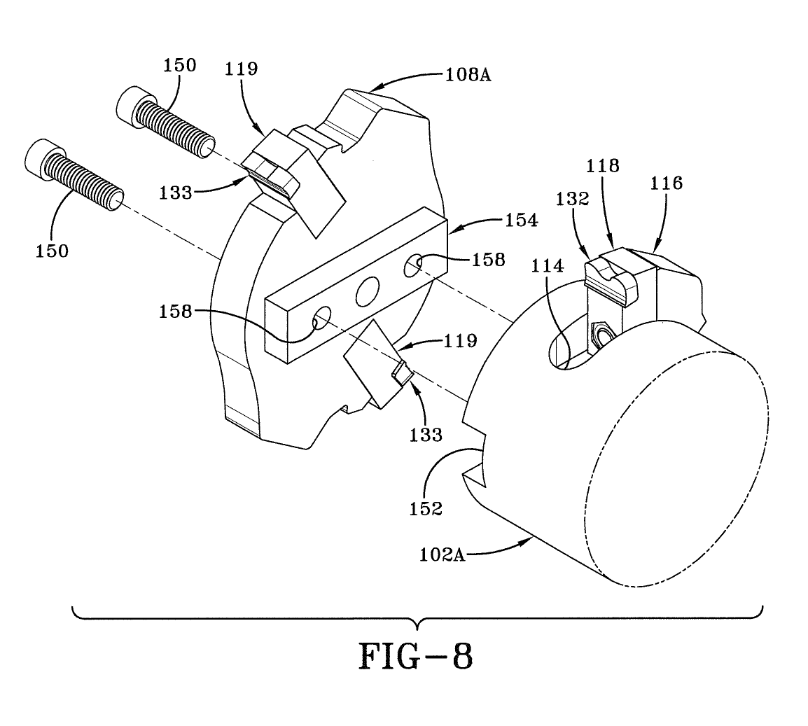

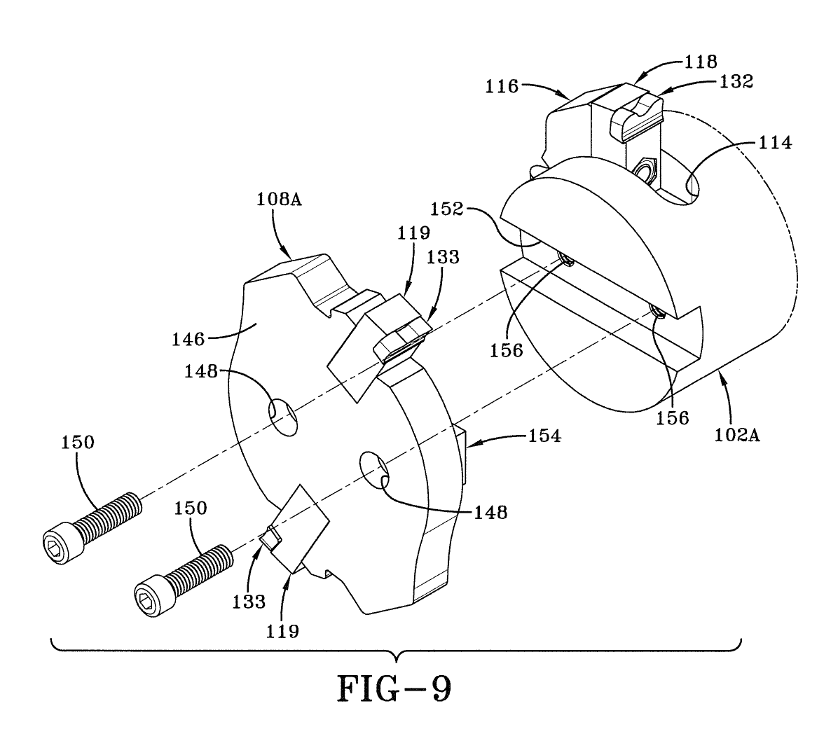

Turning to FIGS. 7-9, grinding tip 108A includes a pair of cutting members 119 with a corresponding cutting tip 133, a generally rectangular protrusion 154 and a grinding attachment 146. Protrusion 154 is rigidly attached to grinding tip 108A, typically by welding and is formed with a pair of openings 158. Cutting member 119 is typically rigidly attached to grinding tip 108A by welding. It is contemplated that cutting member 119 may be removably attached to grinding tip 108A. Grinding attachment 146 is generally disk shaped, generally composed of a metal carbide alloy, and is formed with a pair of openings 148. Cutting tips 133 are generally located on the outer diameter of grinding tip 108A and generally opposite of one another.

To attach grinding tip 108A to grinding shaft 102A, grinding shaft is formed with a slot 152 opposite base portion 104 (FIG. 3). Slot 152 is formed with a pair of openings 156. Protrusion 154 slides into opening 156 and a fastener 150, including a bolt, is generally disposed in opening 148, through opening 158, and into opening 156 to removably attach grinding tip 108A to grinding shaft 102A. In this manner, grinding tip 108A withstands the harsh underground environment by utilizing multiple connection points including bolts 150 and protrusion 154.

The removable attachment facilitates the replacement of grinding tip 108A as the grinding tip is exposed to a harsh environment that may include rocks, clay, tree roots, tree stumps, and/or other debris that may damage and/or break the grinding tip. Additionally, the rotation and weight of grinding tip 108A, grinding shaft 102A and base portion 104 creates a flywheel effect generating more torque to grind and/or cut tree stumps and other corresponding debris facilitating removal of the tree stump and other debris. Further, it is contemplated that additional weighted rings may be added to provide an increased flywheel effect to grind and/or cut tree stumps and other corresponding debris facilitating removal of the tree stump and other debris, as will be discussed.

Improved cutting shaft for vertical stump grinder 100 of the present invention facilitates the easy removal and replacement of individual cutting portion 118 of cutting tooth 112A upon the cutting portion becoming broken and/or worn out. In this manner, improved cutting shaft for vertical stump grinder 100 reduces down time for use of the vertical stump grinder of the present invention and minimizes costs as a result of simply replacing the worn out and/or broken cutting portion 118. Further, grinding tip 108A is removable and replaceable upon becoming worn out and/or damaged as a result of the harsh tree stump grinding environment. It is contemplated that other structures for grinding shaft 102A, grinding tip 108A and/or cutting tooth 112A may be utilized, as will be described.

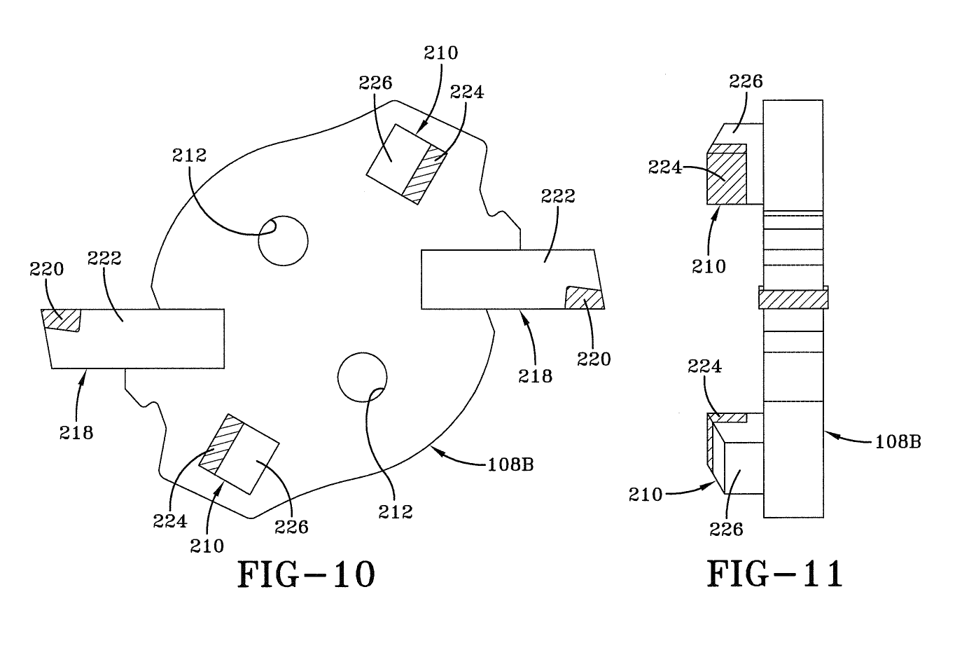

For example, turning to FIGS. 10-11, an alternative puck or grinding tip 108B is shown. Grinding tip 108B is generally disk shaped and includes a cutting member 218, a grinding protrusion 210, and is formed with an at least one opening 212. Grinding tip 108B includes grinding protrusions 210 that extends outwardly from the grinding tip. In this manner, grinding protrusion 210 grinds tree stumps, soil, and other debris upon use of grinding tip 108B. Generally, a fastener (not shown), such as a bolt, is disposed in opening 212 to removably attach grinding tip 108B to a bottom end of improved cutting shaft for vertical stump grinder 100 of the present invention.

Cutting member 218 includes a cutting tip 220 and a cutting support 222. Cutting tip 220 is generally composed of a metal carbide alloy, and is rigidly attached to cutting support 222, preferably by brazing. Further, cutting support 222 is rigidly attached to grinding tip 108B, typically by welding. Cutting members 218 are generally located on the outer diameter of grinding tip 108B and generally opposite of one another. It is contemplated that cutting support 222 may be removably attached to grinding tip 108B, using a fastener (not shown), such as a bolt. In this manner, grinding tip 108B is constructed to withstand the harsh underground grinding environment.

Grinding protrusion 210 includes a grinding edge 224 and an edge support 226. Grinding edge 224 is rigidly attached to edge support 226, preferably by brazing. As a result of grinding protrusions 210 extending downwardly from grinding tip 108B, grinding tip 108B forms a buffer to minimize the interaction of the grinding tip with the underground environment. More specifically, grinding protrusion 210 maintains some spacing between grinding tip 108B and the underground environment. In this manner, improved cutting shaft for vertical stump grinder 100 will rotate even if grinding tip 108B comes into contact with the underground environment. This further extends the life of grinding tip 108B because grinding protrusion 210 limits the amount of contact with the underground environment.

Additionally, the removable attachment of grinding tip 108B to improved cutting shaft for vertical stump grinder 100 facilitates the replacement of the grinding tip as the grinding tip is exposed to a harsh environment that may include rocks, clay, tree roots, and/or tree stumps that may damage and/or break the grinding tip. Further, the rotation and weight of grinding tip 108B, grinding shaft 102A, and base portion 104 creates a flywheel effect generating more torque to grind and/or cut tree stumps and other corresponding debris facilitating removal of the tree stump and other debris. Additionally, it is contemplated that additional weighted rings may be added to provide an increased flywheel effect to grind and/or cut tree stumps and other corresponding debris facilitating removal of the tree stump and other debris, as will be discussed.

Grinding tip 108B of improved cutting shaft for vertical stump grinder 100 is a replaceable attachment that includes grinding protrusion 210 and cutting member 218 to facilitate grinding away the harsh environment corresponding to the tree stump and the location surrounding the tree stump. The placement of the grinding protrusion 210 and cutting member 218 allow for grinding in both a horizontal and vertical direction to facilitate faster grinding times of the stump and corresponding area while maintaining a buffer area between grinding tip 108B and the harsh environment to maintain the rotation of improved cutting shaft for vertical stump grinder 100.

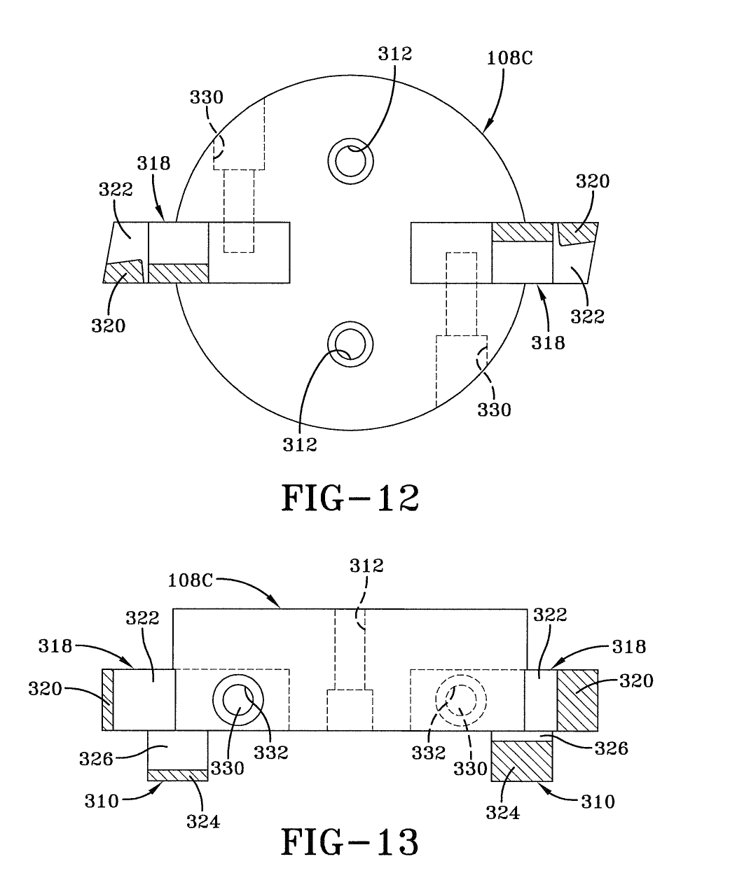

Turning to FIGS. 12-13, another example of a grinding tip 108C for improved cutting shaft for vertical stump grinder 100 is shown. Grinding tip 108C is generally disk shaped and includes a cutting member 318, a grinding protrusion 310, and is formed with an at least one opening 312 to attach the grinding tip to the improved cutting shaft for vertical stump grinder 100. Grinding tip 108C includes grinding protrusion 310 that extends downwardly from the grinding tip. In this manner, grinding protrusion 310 grinds tree stumps, soil, and other debris upon use of improved cutting shaft for vertical stump grinder 100. Additionally, cutting member 318 and grinding protrusion 310 are a single-piece facilitating the replacement of the cutting portion and the grinding protrusion thus minimizing replacement time because of the single-piece.

Cutting member 318 and grinding protrusion 310 are removably connected to grinding tip 108C using a fastener 330, such as a bolt, disposed in an opening 332. In this manner, each cutting member 318 and grinding protrusion 310 can be individually removed and replaced from grinding tip 108C. Additionally, each cutting member 318 and grinding protrusion 310 are located opposite of one another on grinding tip 308 to equalize the weight for when the grinding tip is rotating connected to improved cutting shaft for vertical stump grinder 100.

Cutting member 318 includes a cutting tip 320 and a cutting support 322. Cutting tip 320 is generally composed of a metal carbide alloy, and is rigidly attached to cutting support 322, preferably by brazing. Cutting members 318 are generally located on the outer diameter of grinding tip 108C and generally opposite of one another.

Grinding protrusion 310 includes a grinding edge 324 and an edge support 326. Grinding edge 324 is rigidly connected to edge support 326, preferably by brazing. As a result of grinding protrusions 310 extending outwardly from grinding tip 108C, the grinding tip forms a buffer to minimize the interaction of the improved cutting shaft for vertical stump grinder 100 with the environment underground. More specifically, grinding protrusion 310 maintains some spacing between grinding tip 108C and the underground environment. In this manner, improved cutting shaft for vertical stump grinder 100 will rotate even if grinding tip 108C comes into contact with the underground environment. This further extends the life of grinding tip 108C because grinding protrusion 310 limits that amount of contact with the underground environment.

Additionally, the removable attachment of grinding tip 108C to improved cutting shaft for vertical stump grinder 100 facilitates the replacement of the grinding tip as the grinding tip is exposed to a harsh environment that may include rocks, clay, tree roots, and/or tree stumps that may damage and/or break the grinding tip. Further, the rotation and weight of grinding tip 108C, grinding shaft 102A, and base portion 104 creates a flywheel effect generating more torque to grind and/or cut tree stumps and other corresponding debris facilitating removal of the tree stump and other debris. Additionally, it is contemplated that additional weighted rings may be added to provide an increased flywheel effect to grind and/or cut tree stumps and other corresponding debris facilitating removal of the tree stump and other debris, as will be discussed.

Grinding tip 108C of improved cutting shaft for vertical stump grinder 100 is a removable attachment that includes grinding protrusion 310 and cutting member 318 to facilitate grinding away the harsh environment corresponding to the tree stump and the location surrounding the tree stump. The placement of the grinding protrusion 310 and cutting member 318 allow for grinding in both a horizontal and vertical direction to facilitate faster grinding times of the stump, and corresponding area, while maintaining a buffer area between grinding tip 108C and the harsh environment to maintain the rotation of improved cutting shaft for vertical stump grinder 100.

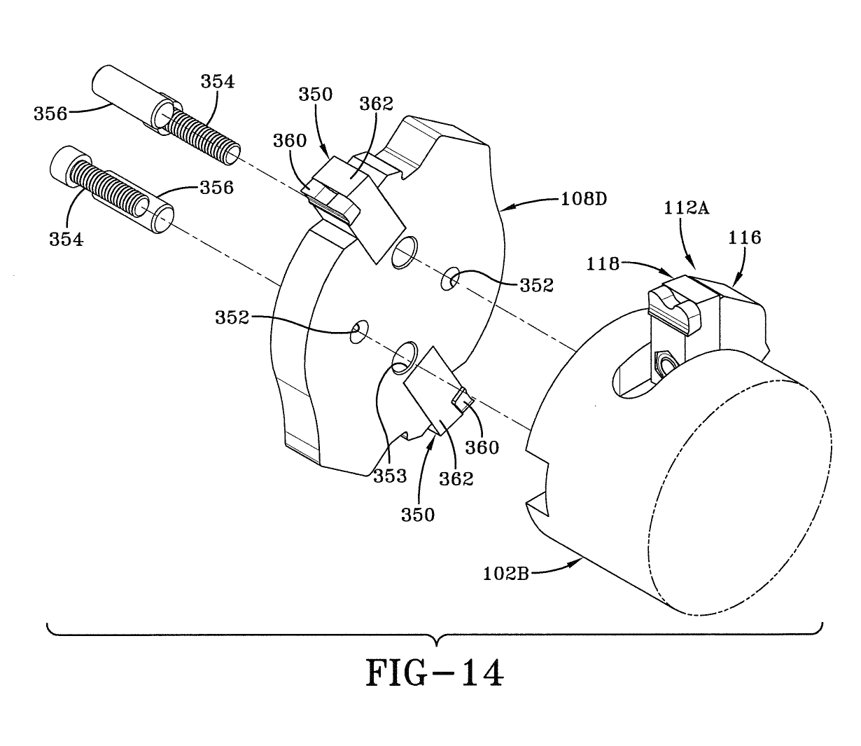

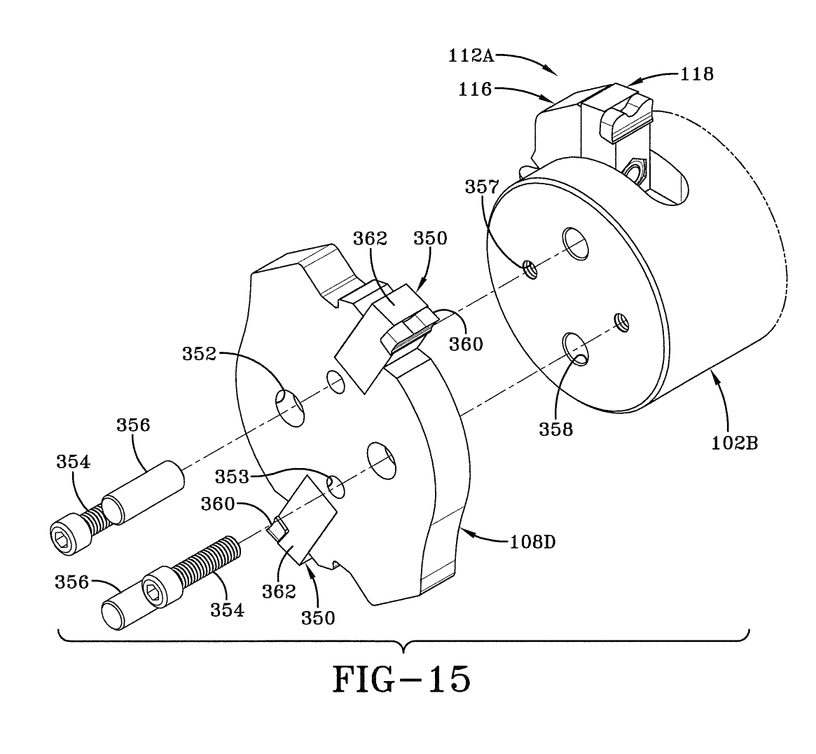

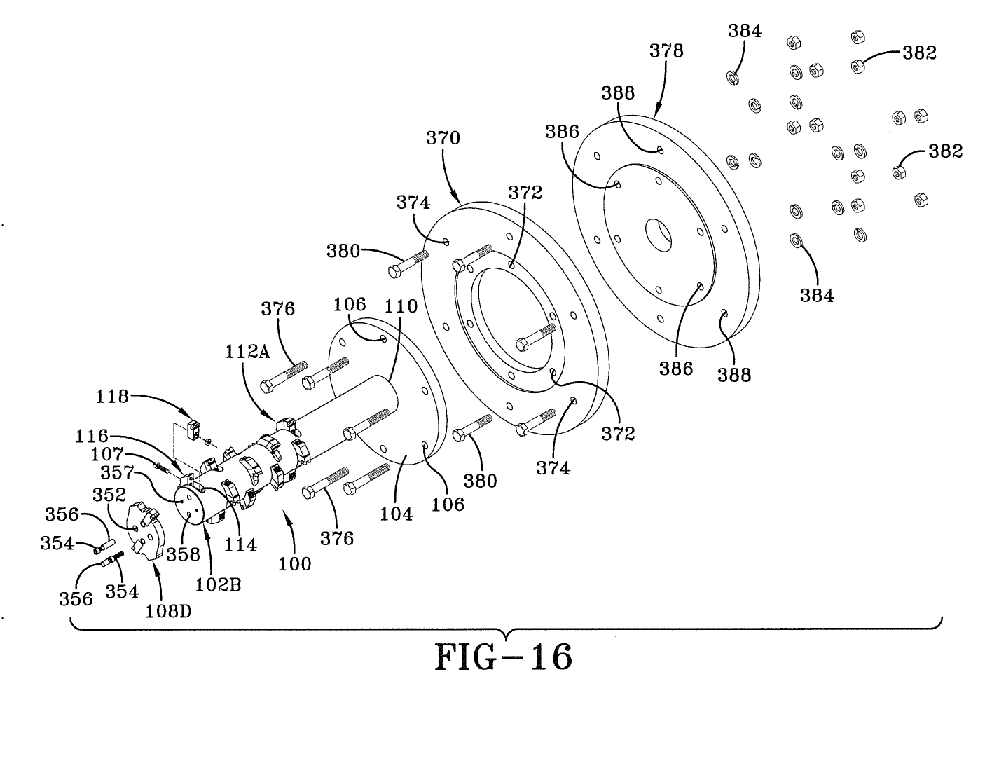

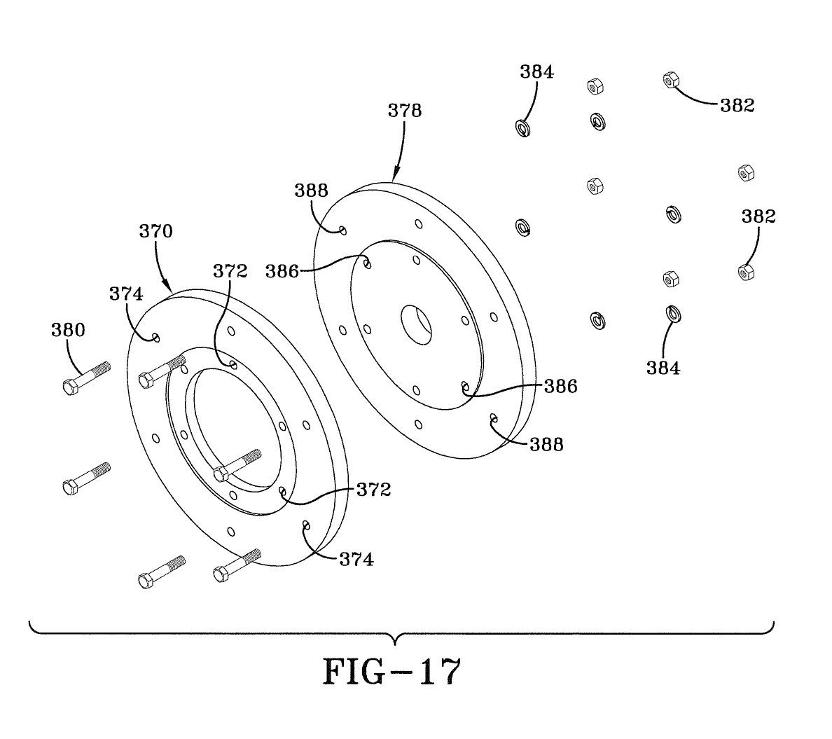

Turning to FIGS. 14-15, another example of a grinding tip 108D for improved cutting shaft for vertical stump grinder 100 is shown. Grinding tip 108D is generally disk shaped, includes a cutting member 350 and is formed with at least one bolt opening 352 and an at least one pin opening 353, opposite base portion 104. Generally, fasteners, including a bolt 354, and a pin 356 are disposed in opening 352, 353, respectively, to removably attach grinding tip 108D to a grinding shaft 102B. Further, grinding shaft 102B is formed with an at least one pin opening 357 and an at least one bolt opening 358 to receive bolt 354 and pin 356, respectively. Pins 356 help to locate corresponding openings 357, 358 in grinding shaft 102B to secure grinding tip 108D to the grinding shift. Additionally, pins 356 provide additional resistance to torque that potentially occurs upon utilization of grinding shaft 102B and tip 108D. In this manner, grinding tip 108D is attached to grinding shaft 102B and able to withstand the harsh underground grinding environment.

Cutting member 350 includes a cutting tip 360 and a cutting support 362. Cutting tip 360 is generally composed of a metal carbide alloy, and is rigidly attached to cutting support 362, preferably by brazing. Further, cutting support 362 is rigidly attached to grinding tip 108D, typically by welding. It is contemplated that cutting support 362 may be removably attached to grinding tip 108D, using a fastener (not shown), as a bolt. In this manner, grinding tip 108D is constructed to withstand the harsh underground grinding environment.

Additionally, the removable attachment of grinding tip 108D to improved cutting shaft for vertical stump grinder 100 facilitates the replacement of the grinding tip as the grinding tip is exposed to a harsh environment that may include rocks, clay, tree roots, and/or tree stumps that may damage and/or break the grinding tip. Further, the rotation and weight of grinding tip 108D, grinding shaft 102B, and base portion 104 creates a flywheel effect generating more torque to grind and/or cut tree stumps and other corresponding debris facilitating removal of the tree stump and other debris. Additionally, it is contemplated that additional weighted rings may be added to provide an increased flywheel effect to grind and/or cut tree stumps and other corresponding debris facilitating removal of the tree stump and other debris.

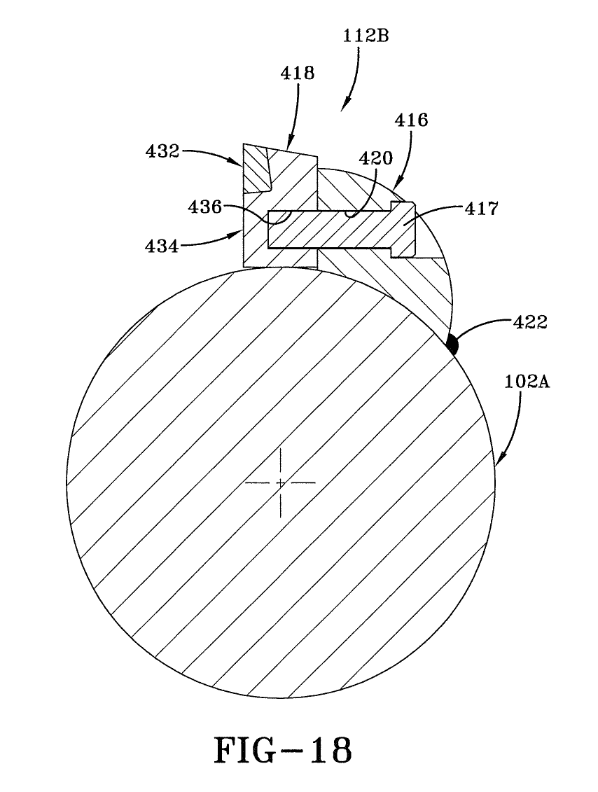

Turning to FIGS. 16-17, a weighted ring 370 that is generally disk shaped is shown. Ring 370 is formed with an at least one base opening 372 and an at least one grinding machine opening 374. Improved cutting shaft for vertical stump grinder 100 is removably attached to ring 370 utilizing fasteners, such as bolts 376. Each bolt 376 is disposed through a respective aligned one of openings 106 and through openings 372. Additional rings 370 may be added to increase the flywheel effect to grind and/or cut tree stumps and other corresponding debris facilitating removal of the tree stump and other debris.

Weighted ring 370 is removably attached to a grinder flange 378 utilizing fasteners, including bolts 380, nuts 382, and washers 384. Grinder flange 378 is formed with ring openings 386 and grinder openings 388. Ring 370 is removably attached utilizing bolts 380, nuts 382, and washers 384, by disposing the bolts through respective aligned one of openings 374 and opening 388 and tightening the respective nut. Additionally to provide a more secured attachment, bolts 376 are disposed through each respective aligned openings 106, openings 372, and openings 386. In this manner, there is a secured attachment of vertical stump grinder 100, ring 370, and grinder flange 378 to create a flywheel effect generating increased force to grind and/or cut tree stumps and other corresponding debris facilitating removal of the tree stump and other debris. More specifically, the additional weight of ring 370 at the upper end of grinding shaft 102B provides an increased flywheel effect as a result of the weight of the ring being near drive source 26 (FIG. 1). Thus, more force is generated and transferred to grinding shaft 102B.

Turning to FIGS. 18-22, further examples of attaching a cutting tooth to improved cutting shaft for a vertical stump grinder 100 of the present invention are shown. For example, a cutting tooth 112B is shown attached to grinding shaft 102A in FIG. 18.

Cutting tooth 112B includes a backer support 416 and a cutting portion 418. Backer support 416 is generally rigidly attached, preferably by welding, to grinding shaft 102A, includes a tail portion 422 and is formed with an opening 420. Tail portion 422 provides additional surface area to weld backer support 416 to grinding shaft 102A. In this manner, backer support 416 is rigidly attached to grinding shaft 102A to provide support for cutting portion 418.

Cutting portion 418 is generally rectangular in shape and includes a cutting tip 432 and a cutting tip support 434. Cutting tip support 434 is rigidly attached to cutting tip 432 and formed with an opening 436. Cutting tip 432 is rigidly attached to cutting tip support 434, preferably by brazing. Cutting tip 432 is generally made of a metal carbide alloy, as known to those skilled in the art.

In an important aspect of the present invention, cutting portion 418 is removably attached to backer support 416. More specifically, once backer support 416 is welded to grinding shaft 102A to provide proper alignment for cutting portion 418, opening 436 of cutting tip support 434 is aligned with opening 420 of the backer support and a fastener 417 is disposed therein. In this manner, cutting portion 418 is removably attached to backer support 416 and may be removed if the cutting portion becomes worn out and/or broken or otherwise needs replacement.

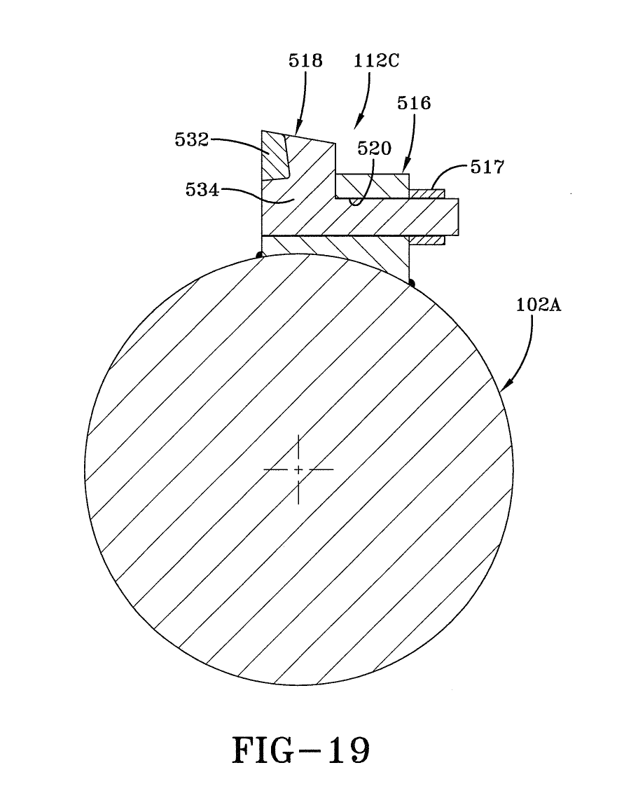

Turning to FIG. 19, another example of attaching cutting tooth to improved cutting shaft for a vertical stump grinder 100 of the present invention is shown. A cutting tooth 112C is shown attached to grinding shaft 102A in FIG. 19. Cutting tooth 112C includes a backer support 516 and a cutting portion 518. Backer support 516 is generally rigidly attached to grinding shaft 102A, and is formed with an opening 520. Backer support 516 includes an extended curved portion to conform to grinding shaft 102A and generally extends the length of cutting portion 518 to provide a better rigid attachment to the grinding shaft to provide support for cutting portion.

A backer 517 is removably attached adjacent to backer support 516 to secure cutting portion 518 to the backer support, as will be described. Cutting portion 518 is generally rectangular with an extended shaft that includes a cutting tip 532 and a cutting tip support 534. Cutting tip support 534 extends and is disposed within opening 520 of backer support 516. Cutting tip 532 is rigidly attached to cutting tip support 534, preferably by brazing. Cutting tip 532 is generally composed of a metal carbide alloy.

In an important aspect of the present invention, cutting portion 518 is removably attached to backer support 516. More specifically, cutting tip support 534 of cutting portion 518 extends and is disposed within opening 520 of backer support 516. Backer 517 secures cutting tip portion 534 and the backer is removable if cutting portion 518 becomes worn out and/or broken or otherwise needs replacement.

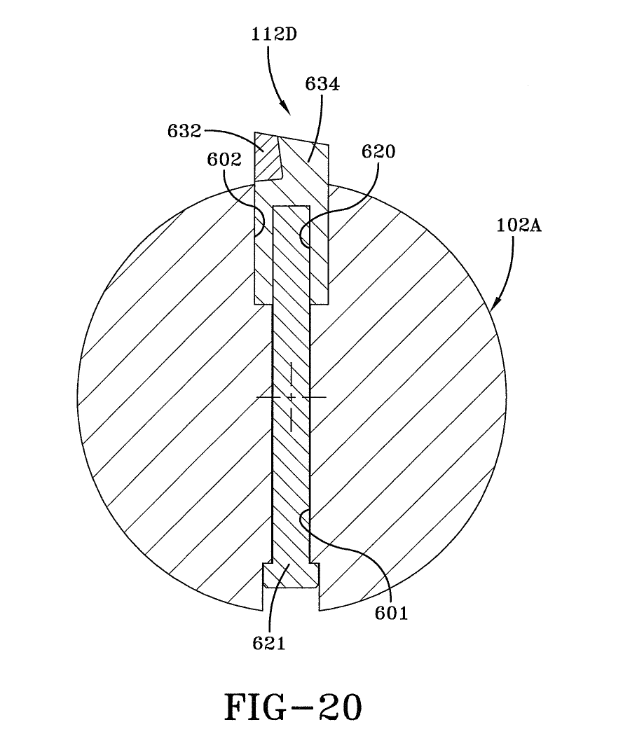

Turning to FIG. 20, another example of attaching cutting tooth to improved cutting shaft for a vertical stump grinder 100 of the present invention is shown. A cutting tooth 112D is shown attached to grinding shaft 102A. Grinding shaft 102A is formed with a first opening 601 that passes through the grinding shaft. Grinding shaft 102A is also formed with a second opening 602 of a larger diameter than first opening 601, and which aligns with the first opening from the opposite end of the diameter of the grinding shaft. Cutting tooth 112D includes a cutting tip support 634 and a cutting tip 632. Cutting tip 632 is generally rigidly attached to cutting tip support 634, preferably by brazing. Cutting tip 632 is generally made of a metal carbide alloy. Cutting tip support 634 is received in second opening 602, and in turn is formed with a threaded opening 620. A fastener 621, including a bolt, is disposed within first opening 601 and is secured in threaded opening 620 to removably attach cutting tooth 112D to grinding shaft 102A. In this manner, fastener 621 removably attaches cutting tooth 112D to grinding shaft 102A and the cutting tooth may be removed if it becomes worn out and/or broken or otherwise needs replacement.

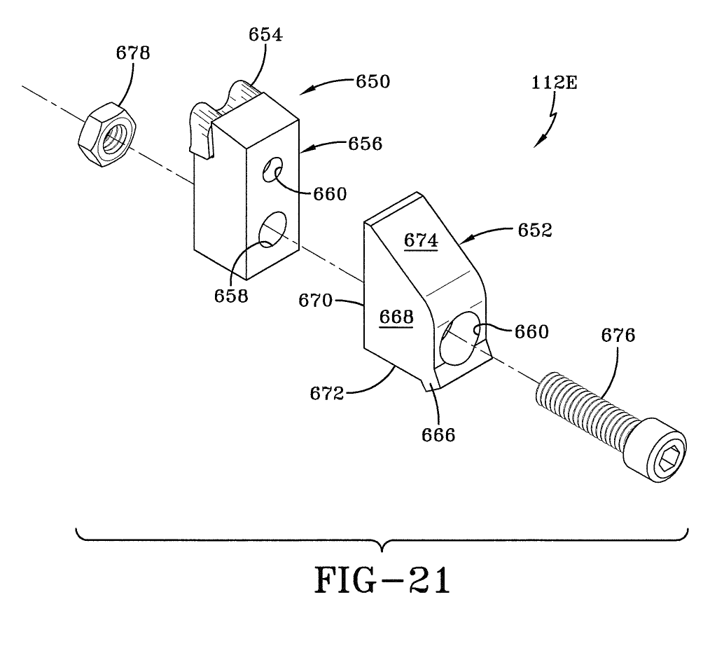

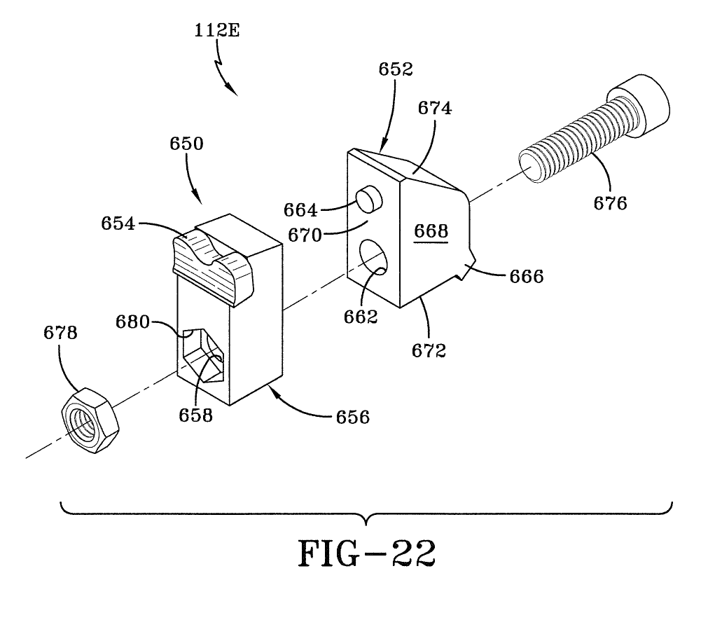

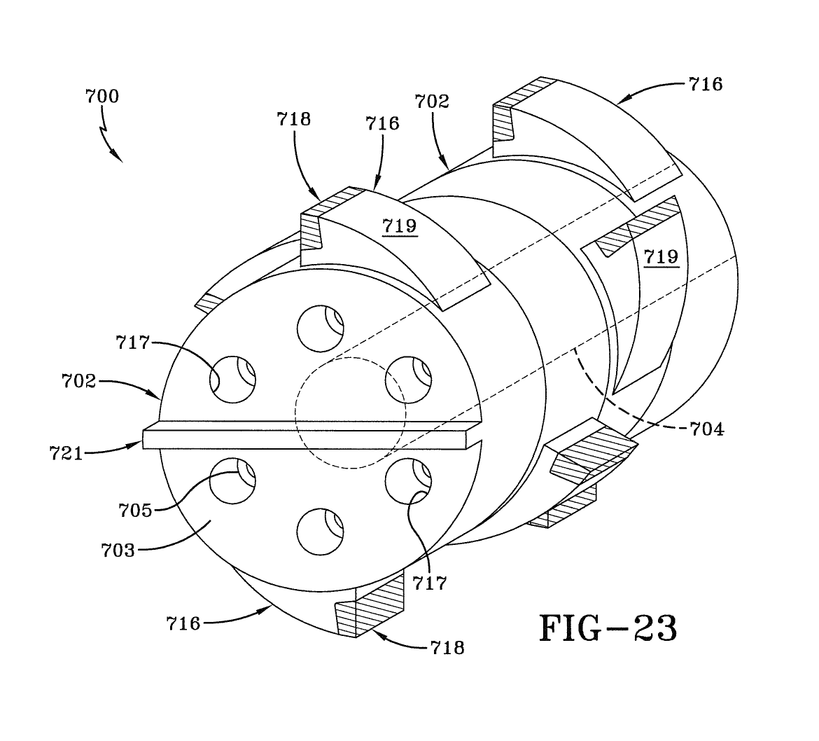

Turning to FIG. 21-22, a cutting tooth 112E is shown. Cutting tooth 112E includes a cutting portion 650 and a backer support 652. Cutting portion 650 is generally rectangular in shape and includes a cutting tip 654 and a cutting tip support 656. Cutting tip 654 is generally made of a metal carbide alloy, as known to those skilled in the art, and includes a generally elongated “m-shape”, but other shapes, including a generally “U-shape”, are contemplated. Cutting tip support 656 is rigidly connected to cutting tip 654, preferably by brazing. Cutting tip support 656 is formed with an at least one opening 658 and an at least one opening 660.

Backer support 652 is generally rectangular in shape and formed with an opening 662, a protrusion 664, a tail portion 666, a pair of side portions 668 (only one shown), a cutting support portion 670, a base portion 672, and an angled portion 674. Tail portion 666 provides an optimum weld location and helps to align backer support 652 with respect to groove 114. Base portion 672 seats in and is rigidly attached to groove 114 by welding or other means known by those in the art. In addition, tail portion 666 provides additional surface area to attach backer support 652 to grinding shaft 102A. In this manner, backer support 652 is rigidly attached to grinding shaft 102A. Preferably, backer support 652 is welded within groove 114 of grinding shaft 102A. Further, tail portion 666 provides a locating means for correct positioning of backer support 652 within groove 114. In this manner, backer support 652 is preferably positioned upon grinding shaft 102A and assists the installation of the backer support.

In an important aspect, cutting portion 650 is removably attached to backer support 652. More specifically, once backer support 652 is welded into groove 114 to provide proper alignment for cutting portion 650, the cutting portion is abutted against cutting support portion 670 of the backer support to align opening 660 to protrusion 664 and opening 658 and opening 662, respectively. A fastener, including a bolt 676, is disposed through opening 660 and opening 658, and a nut 678 is threaded onto the bolt. Nut 678 seats in a recess 680 formed in cutting tip support 656 to prevent rotation of the nut and to provide protection from abrasive conditions. In this manner, protrusion 664 disposed in opening 660 limits the potential movement of cutting portion 650, providing a consistent removable attachment of the cutting portion and backer support 652.

As discussed above, cutting teeth 112B, 112C, 112D, 112E provide various attachments to grinding shaft 102A of improved cutting shaft for a vertical stump grinder 100 of the present invention. Each cutting tooth 112B, 112C, 112D, and 112E respectively, is removable and replaceable upon becoming worn out and/or broken or otherwise requiring replacement. Additionally, only cutting tooth 112B, 112C, 112D, and 112E is required to be replaced and not the entire grinding shaft 102A, 102B for vertical stump grinder 100 of the present invention. In this manner, replacement cost and downtime are minimized.

Turning to FIG. 23, a second embodiment of improved cutting shaft for vertical stump grinder of the present invention is indicated generally at 700. Second embodiment of improved cutting shaft for vertical stump grinder 700 includes a plurality of interlocking segments 702 that are positioned around a vertically-extending central rod 704. Interlocking segments 702 include a backer support 716, a cutting portion 718, and is formed with a plurality of openings 717.

A fastener 705 is disposed within opening 717 to connect terminal end interlocking segments 702 to central rod 704. Additionally, the fastener may further connect adjacent interlocking segments 702 to strengthen the connection to central rod 704. Terminal end interlocking segment 702 may include grinding tip 108A (FIG. 7) to further facilitate grinding away the harsh environment corresponding to the tree stump and the location surrounding the tree stump. Interlocking segments 702 allow for the length of second embodiment of improved cutting shaft for vertical stump grinder 700 to be adjusted according to the size of the tree stump such that additional segments may be added for tree stumps that have roots that are deeper. Further, interlocking segments 702 may be removed from second embodiment of improved cutting shaft for vertical stump grinder 700 thus shortening the length of the cutting shaft for shallower tree stumps.

A connected plurality of interlocking segments 702 generally staggers backer support 716 and cutting portion 718 along the vertical length of the connected plurality of interlocking segments. This staggered positioning facilitates more efficient grinding of the tree stump and corresponding area.

Backer support 716 is rigidly attached to interlocking segment 702 generally by welding. Backer support 716 includes a curved portion 719 that minimizes contact with the tree stump and corresponding area while second embodiment of improved cutting shaft for vertical stump grinder 700 is rotating.

Cutting portion 718 is rigidly attached to backer support 716, generally by brazing, and is generally composed of a metal carbide alloy. As second embodiment of improved cutting shaft for vertical stump grinder 700 rotates, cutting portion 718 cuts and/or grinds the tree stump and corresponding area.

To further cut and/or grind the tree stump and corresponding area, second embodiment of improved cutting shaft for vertical stump grinder 700 includes interlocking segment 702 on a terminal end 703 that includes a protrusion 721. Protrusion 721 facilitates in grinding and cutting the tree stump and corresponding area and prevents the terminal face of interlocking segment 702 from contacting the ground. By preventing the contact with the ground, the potential reduction of rotational speed of second embodiment of improved cutting shaft for vertical stump grinder 700 is minimized.

Upon extensive use and/or requiring replacement, interlocking segment 702 of second embodiment of improved cutting shaft for vertical stump grinder 700 may be removed and replaced by removing the fastener and removing the worn out and/or broken segment. In this manner, second embodiment of improved cutting shaft for vertical stump grinder 700 reduces down time for use of the improved cutting shaft for vertical stump grinder and minimizes costs as a result of replacing the broken and/or worn out interlocking segment 702.

It is to be understood that the above described structure of an improved cutting shaft for vertical stump grinder 100, 700, may be altered without affecting the overall concept or operation of the present invention. For example, any combination of grinding tip 108A, 108B, 108C, 108D, and cutting tooth 112A, 112B, 112C, 112D, and 112E may be utilized. In addition, first and second embodiment improved cutting shaft for vertical stump grinder 100, 700 may be rotated about a horizontal axis. Further, cutting tip 132, 220, 320, 432, 532, and 632 and/or grinding edge 224, 324 may be constructed out of other materials than an alloy without affecting the overall concept or operation of the invention. Additionally, grinding shaft 102A, 102B may be formed without grooves 114 without affecting the overall concept or operation of the invention. Further, weighted ring 370 may be utilized on improved cutting shaft for vertical stump grinder 100, 700.

Moreover, any number or combination of cutting teeth 112A, 112B, 112C, 112D, and 112E, and/or cutting members 218, 318, and 350, and cutting portion 718 and/or grinding protrusion 210, 310 may be utilized without affecting the overall concept or operation of the invention. Moreover, different shapes and/or configurations of grinding tip 108A, 108B, 108C, and 108D, backer support 116, 416, 516, cutting tooth 112A, 112B, 112C, 112D, and 112E, and/or grinding attachment 146 may be utilized on improved cutting shaft for vertical stump grinder 100, 700.

Accordingly, the improved cutting shaft for vertical stump grinder is simplified, provides an effective, safe, inexpensive and efficient structure and method which achieves all the enumerated objectives, provides for eliminating difficulties encountered with prior art stump grinder, and solves problems and obtains new results in the art.

In the foregoing description, certain terms have been used for brevity, clearness and understanding; but no unnecessary limitations are to be implied therefrom beyond the requirements of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the improved cutting shaft for vertical stump grinder is used and installed, the characteristics of the construction, arrangement and method steps, and the advantageous, new and useful results obtained; the new and useful structures, devices, elements, arrangements, process, parts and combinations are set forth in the appended claims.

What is claimed is:

1. An improved cutting shaft for a vertical stump grinder, said cutting shaft including:
a base portion attached to a drive source;
a grinding shaft attached to and extending downwardly from said base portion; and
at least one cutting tooth removably attached to said grinding shaft.

2. The improved cutting shaft for a vertical stump grinder of claim 1, further includes said cutting tooth includes a backer support wherein said backer support is rigidly attached to said grinding shaft.

3. The improved cutting shaft for a vertical stump grinder of claim 2, wherein said cutting tooth includes a cutting portion, and said cutting portion is removably attached to said backer support.

4. The improved cutting shaft for a vertical stump grinder of claim 3, wherein said grinding shaft includes a groove, wherein said backer support is rigidly attached to said groove.

5. The improved cutting shaft for vertical stump grinder of claim 3, wherein said cutting portion extends through said backer support.

6. The improved cutting shaft for vertical stump grinder of claim 3, said cutting tooth includes a cutting portion, and said backer support including a protrusion being disposed in an opening in said cutting portion.

7. The improved cutting shaft for a vertical stump grinder of claim 1, wherein said cutting tooth includes a cutting portion, and said cutting portion includes a cutting tip composed of a metal carbide alloy.

8. The improved cutting shaft for a vertical stump grinder of claim 1, further including a grinding tip removably attached to a bottom end of said grinding shaft.

9. The improved cutting shaft for vertical stump grinder of claim 8, wherein said grinding tip includes at least one cutting member.

10. The improved cutting shaft for vertical stump grinder of claim 9, wherein said grinding tip further includes at least one grinding protrusion.

11. The improved cutting shaft for vertical stump grinder of claim 10, wherein said cutting member and said grinding protrusion are a single-piece unit.

12. The improved cutting shaft for vertical stump grinder of claim 8, wherein said grinding tip is removably attached with at least one pin.

13. The improved cutting shaft for vertical stump grinder of claim 1, further including a weighted ring removably attached to said grinding shaft.

14. The improved cutting shaft for vertical stump grinder of claim 1, wherein said removable cutting tooth is removably connected by a bolt disposed through said grinding shaft.

15. The improved cutting shaft for vertical stump grinder of claim 1, wherein said removably attached cutting tooth is attached to said grinding shaft by a mechanical fastener.

16. An improved cutting shaft for a vertical stump grinder, said cutting shaft including:
a base portion attached to a drive source;
a grinding shaft attached to and extending downwardly from said base portion; and
a grinding tip removably attached to a bottom end of said grinding shaft.

17. The improved cutting shaft for vertical stump grinder of claim 16, wherein said grinding tip includes at least one cutting member.

18. The improved cutting shaft for vertical stump grinder of claim 17, wherein said grinding tip further includes at least one grinding protrusion.

19. The improved cutting shaft for vertical stump grinder of claim 16, wherein said grinding shaft further includes at least one cutting tooth attached to said grinding shaft and said cutting tooth includes a removable cutting portion.

20. An improved cutting shaft for vertical stump grinder, said cutting shaft including:
a base portion attached to a drive source;
a grinding shaft attached to and extends downwardly from said base portion, wherein said grinding shaft includes at least two interlocking segments; and
each one of said segments include at least one backer support and at least one cutting portion.
